(19) United States
(12) Patent Application Publication
(10) Pub. No.: US 2008/0039048 A1
(43) Pub. Date: Feb. 14, 2008

(54) Emergency service provision for a supervised wireless device

(76) Inventors: Dennis Turri, Burlington, MA (US); Jennifer Fellows, Hollis, NH (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/891,293

(22) Filed: Aug. 9, 2007

Related U.S. Application Data
(60) Provisional application No. 60/836,825, filed on Aug. 10, 2006.

(51) Int. Cl. H04M 11/04

(52) U.S. Cl. 455/404.1

(57) ABSTRACT

A system and method for permitting communication with a supervised wireless device upon which incoming call restrictions have been placed in the event an emergency service provider attempts to communicate with the supervised wireless device. The emergency service provider, such as a 911 call center, can communicate with a supervised wireless device once incoming call restrictions on the wireless device are disabled. The incoming call restrictions on the supervised wireless device may be disabled during a time interval or until a specific event occurs. The time interval may be resetable, and the event may be an indication of a priority call from an emergency service provider. The disabled restriction may include all restrictions, or a subset of restrictions, such as time of day or incoming call ID restrictions. Calls placed to or received from the emergency service provider may be in the form of voice communications, SMS, MMS, IM, email messages or any other available form. The disabled restrictions may be based on the type or form of the call to the emergency service provider.

### CROSS REFERENCE TO RELATED APPLICATIONS

This application claims benefit under 35 U.S.C. §119(e) of U.S. Provisional Application No. 60/836,825, filed Aug. 10, 2006, entitled EMERGENCY SERVICE PROVISION FOR A SUPERVISED WIRELESS DEVICE.

### STATEMENT REGARDING FEDERALLY SPONSORED RESEARCH OR DEVELOPMENT

Not Applicable

### BACKGROUND OF THE INVENTION

The present invention relates generally to a managed communication system, and relates more particularly to a system and method for removing communication restrictions on a supervised wireless device to permit emergency communications with the device.

Communication restrictions on mobile devices avoid unwanted or inappropriate communications with the mobile device. In one system known as Mobile Guardian™ provided by Boston Communication Group, Inc., a responsible party, or supervisor, causes restrictions to be placed on the use of a wireless device. Restrictions may include an allotment of time per month that the wireless device may be used, hours during which the wireless device may not send or receive communications, and so forth. A typical example where these types of restrictions are employed involves mobile phones used by schoolchildren, with parents or guardians acting as the supervisor. The parent or guardian can restrict the number of minutes per month that the school aged child may use the mobile phone to avoid excess costs associated with usage beyond the monthly time allotment for a given service provider plan. Another typical use of mobile device restriction involves preventing incoming or outgoing communications for the device during school hours or late at night.

One way that a restrictive mobile device system may be implemented is to permit the supervisor to establish a profile for one or more supervised accounts. The supervisor may establish limits on the number of minutes that a wireless device may be used during a specific period, may limit times of day when the wireless device may be used, may prevent communications to be made to or from specified source or destination identifiers (such as telephone numbers or IP addresses), or may impose other restrictions on the use of the wireless device. Generally, the criteria for restriction of use of the wireless device involves preventing incoming and outgoing calls.

Communications for emergency services are typically not restricted on an outgoing basis. For example, the system for managing a wireless device permits outgoing communications to an emergency service, such as by permitting a mobile phone user to dial 911. In some emergency service systems, including services contacted by dialing 911, a callback attempt may be made by the 911 operator. The callback from the 911 operator may be made to ensure that the caller is not in any danger following the original communication from the mobile device user. Due to the restrictions imposed on the use of the mobile device, a subsequent callback from a 911 operator may be blocked.

While it is possible to identify the number of a calling party, this is not helpful in determining whether a callback from a 911 operator should be permitted in a wireless device on which restrictions on the receipt of communications have been imposed. When a callback attempt is made by a 911 operator, typically the number of the 911 operator as the calling party is selected from a pool of numbers that have been assigned to the 911 service. Consequently, it is not practical to identify specific numbers from which calls should always be received by a wireless device.

It would be desirable to permit emergency service communications to a supervised wireless device upon which usage restrictions may be imposed.

### SUMMARY OF THE INVENTION

In accordance with the present invention, a system and method are disclosed for permitting communications to a wireless device on which restrictions on receipt of communications have been imposed. The improved system and method permits return phone calls from an emergency service, such as a service contacted by dialing 911 on a telephone, to pass to the originating mobile device user even if the use of the wireless device would otherwise be restricted due to restrictions imposed by a supervisory platform.

A wireless device employed in conjunction with the presently disclosed system includes a supervisory platform implemented in a communication network that determines whether a communication may be completed to or initiated from the wireless device. When a user originates a communication to an emergency service, the call data is conveyed to the supervisory platform. More specifically, when an emergency call is placed from the supervised wireless device, a communication switch in the communication network to which the wireless device is connected recognizes the emergency call and forwards the same to the emergency service indicated by the emergency call. The communication switch also notifies a Home Location Register (HLR) or a Visitor Location Register (VLR) when the emergency call is made to determine whether the wireless device is a supervised wireless device so that the call data can be directed to the supervisory platform. The determination of whether the wireless device is a supervised wireless device is accomplished by comparing the calling number to a database maintained at the HLR or VLR, as applicable. Upon determining that the wireless device is a supervised wireless device, the call data for the emergency call, including the called number and the calling number, is directed to the supervisory platform. The supervisory platform then removes all restrictions that might prevent receipt of a return communication from an emergency service. More specifically, the supervisory platform disables one or more restrictions that prevent receipt of a communication by the wireless device from which the emergency communication originated. The disclosed system may lift all or a subset of restrictions applied to the wireless device, so that restrictions that would prevent receipt of a return call from an emergency service would not be active.

The disclosed system thus permits return calls from an emergency service to the wireless device used to originate an emergency communication. More specifically, when a callback call is placed from the emergency service to the supervised wireless device, the wireless infrastructure, via use of the Home Location Register (HLR) or Visitor Location Register (VLR), as applicable, determines whether the wireless device is a managed device to permit the call data to be directed to the supervisory platform. Upon determining that the return call is directed to a supervised wireless subscriber, the call data from the return call is conveyed to the supervisory platform. The supervisory platform determines that restrictions that would prevent the completion of the call have been lifted and signals the mobile switching center (MSC) to complete the call from the emergency service provider to the supervised wireless device.

In one embodiment, the supervisory platform reestablishes usage restrictions on the mobile device after the passage of a predetermined period of time following the initial communication to the emergency service. Alternatively, the usage restrictions may be reestablished following a period specified in a supervisory profile that contains usage restrictions and other parameters applicable to the supervised wireless device. Alternately, or in addition, the supervisory platform may remove restrictions until a predetermined event occurs, such as a manual action by an account supervisor or another person responsible for managing the profile of the supervised wireless device.

The supervisory platform may include a time threshold that a system administrator defines, before the expiration of which, calls such as those from emergency services are permitted. The supervisory platform disables restrictions for the wireless device on a dynamic basis to permit the completion of any communication with the supervised wireless device.

Communications with an emergency service provider may be tracked. Information regarding the initiation of communications directed to an emergency service may be provided in the form of a notification or report available to a supervisor or operator of a supervisory account associated with a supervised wireless device. The notification or report may be made accessible through the supervisory platform so that the operator or supervisor can review communications with the emergency service provider. The communications that are tracked and for which notifications or reports are provided may include voice, text or multimedia messaging and data sessions, such as Instant Messaging (IM) or emails. The operator or the supervisor responsible for the supervised account associated with the supervised wireless device can determine if there is any misuse associated with emergency communications to an emergency service provider, for example.

The disclosed system and method are applicable to a number of wireless communication systems, including text and data session communications. Examples of applicable communications include Simple Message Service (SMS) messages, Multimedia Message Service (MMS) messages, Instant Messaging (IM) messages and email messages, among others. All communications with a supervised wireless communication device are considered to be within the scope of application for the present invention.

In another embodiment, the supervisory platform detects an emergency service communication from a supervised wireless device as described above and awaits a subsequent response from the emergency service attempting to initiate a communication to the supervised wireless device. The communication from the emergency service includes an indication of emergency priority. In response to detection of the indication of emergency priority, the supervisory platform removes or over-rides restrictions on the operation of the supervised wireless device. The supervisory platform, in response to detection of the indication of emergency priority, signals the appropriate MSC that the call from the emergency service provider to the supervised wireless device should be completed. Thus, the supervisory platform may permit only the communication with the priority indication to be received by the supervised wireless device without disabling any usage restrictions applicable to the supervised wireless device.

Other features, aspects and advantages of the present invention will be apparent to those of ordinary skill in the art from the Detailed Description of the Invention that follows.

### BRIEF DESCRIPTION OF THE DRAWINGS

The invention will be more fully understood by reference to the following Detailed Description of the Invention taken in conjunction with the accompanying drawings, of which:

FIG. 1 is a diagram of a system operative in accordance with the present invention that includes a supervised wireless device, a supervisory platform containing a supervisory profile containing restrictions pertaining to the supervised wireless device and an emergency service provider;

FIGS. 2a-2b are ping-pong diagrams illustrating activities involved in handling voice communications with emergency service providers;

FIGS. 3a-3b are ping-pong diagrams illustrating activities involved in handling SMS/MMS communications with emergency service providers;

FIGS. 4a-4b are ping-pong diagrams illustrating activities involved in handling data communications with emergency service providers;

FIG. 5a-5b are ping-pong diagrams illustrating activities involved in handling SMS/MMS communications with emergency service providers; and

FIGS. 6a-6b are ping-pong diagrams illustrating activities involved in handling data communications with emergency service providers.

### DETAILED DESCRIPTION OF THE INVENTION

This application claims benefit under 35 U.S.C. §119(e) of U.S. Provisional Application No. 60/836,825, filed Aug. 10, 2006, entitled EMERGENCY SERVICE PROVISION FOR A SUPERVISED WIRELESS DEVICE, the entire contents of which are hereby incorporated by reference herein.

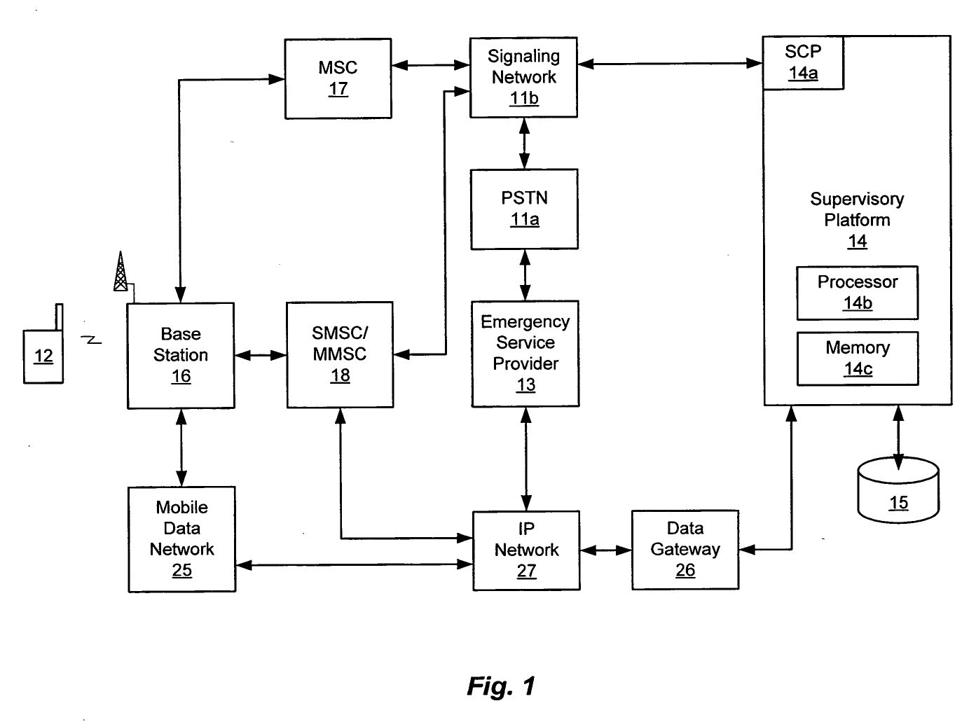

FIG. 1 illustrates system connectivity and operations for a supervised wireless device 12 communicating with an emergency service provider ESP 13. Wireless device 12 is a supervised wireless device that has restrictions that may be imposed on the use of the device based on settings maintained in a supervisory platform 14. Supervisory platform 14 manages communications involving wireless device 12 based in part on a profile database 15. Profile database 15 includes information that indicates whether communications between wireless device 12 and another device should be permitted or blocked.

Information in profile database 15 may indicate, for example, that no incoming or outgoing communication with wireless device 12 may take place between certain hours, such as between the weekday hours of 8:00 am-3:00 pm. The communications may constitute a voice call, a text message, an instant message (IM), an email or any other data communications. Such a restriction on operations for wireless device 12 may correlate, for example, to an avoidance of use during school hours for children. Other restrictions may include a number of minutes per month that wireless device 12 may be used without exceeding a service provider allotment. Typically, exceeding a service provider allotment incurs additional expense in usage of wireless device 12, and restricting wireless device 12 to the base service provider allotment can avoid the additional cost. Moreover, a supervisor may establish a profile for a supervised wireless device that specifies an allotment of a specified number of minutes, text message allotment or email allotment of permitted use that differs from the service provider allotment. Profile database 15 may also include information related to restricted addresses or numbers for wireless device 12. Such a restrictive list is typically referred to as a blacklist, so that any entries provided in the blacklist correspond to restrictions on communications for wireless device 12. A blacklist may include numbers/addresses that may not be called and/or reached from the supervised wireless device and/or numbers that may not originate a communication to the supervised wireless device. Additionally, the supervisor may create a white list, which includes addresses or numbers of persons who may always be contacted or who may contact the wireless device.

Many other types of restrictions are possible, based on length of time, time of day, day of week, and so forth. In addition, wireless device 12 may be any type of wireless device that communicates over a network including mobile telephones, wireless enabled PDAs, portable computers and so forth. Various networks may carry messages between wireless device 12 and ESP 13, including a switched network 11 and an IP network 27. Switched network 11 may be a telephone network, which may include a publicly switched telephone network (PSTN) 11a that connects voice calls, and a signaling network 11b that provides signaling and control for switched network 11. According to an exemplary embodiment, wireless device 12 may communicate using IP addresses, short code identifiers or telephone numbers, for example. Because of the different designation schemes for identifying participants in the different networks, profile database 15 may include IP addresses, short code identifiers or telephone numbers, or other network participant identifiers, for example.

Communications from supervised wireless device 12 typically pass through a base station 16 that includes various antennas and transceivers for wireless communications. The communications involved with wireless device 12 may be a voice communication (or call), a text message, such as a Short Message Service (SMS) text message, a Multimedia Message Service (MMS) message, an Instant Message (IM), an email or any other data session communication.

Voice communications are handled with a Mobile Switch Center (MSC) 17, while text messages are handled through an SMS Center (SMSC) or a Multimedia Message Service Center (MMSC) 18. Data transmissions are conveyed through a Mobile Data Network (MDN) 25. Irrespective of the type of communication, the communication message is steered through network 11 or through IP network 27 to permit communication between wireless device 12 and one or more other communication devices accessible through network 11 or IP network 27.

When a call is made by, or directed to supervised wireless device 12, a lookup is performed in an HLR or VLR associated with the applicable MSC 17. If the lookup results in a determination that the device is a supervised wireless device, the call data associated with the voice communication is redirected to supervisory platform 14.

MSC 17 forwards emergency service calls to ESP 13 without intervention or restriction from supervisory platform 14. The emergency service calls receive bifurcated treatment in that MSC 17 also forwards a notification message to supervisory platform 14 when an emergency service call is placed. That is, the HLR or VLR are notified specifically in the case of an emergency service call, as MSC 17 can be “hard wired” to direct emergency service calls to ESP 13 without processing that may occur in normal calls. The notification to the HLR or VLR causes restrictions on return calls to wireless device 12 to be disabled, as subsequently described in greater detail. After ESP 13 handles the emergency communication, operators at ESP 13 sometimes initiate a callback communication to supervised wireless device 12 to ensure that any emergency situation has been resolved or is in the process of being resolved. In particular, when ESP 13 is a 911 call center, 911 operators may initiate a callback communication to wireless device 12 after the initial emergency communication is received from wireless device 12. Because wireless device 12 is managed by supervisory platform 14, absent special handling by supervisory platform 14, a communication initiated by ESP 13 may be restricted due to one or more settings in the profile database 15. In addition, identifiers for 911 operators, such as telephone numbers, are drawn from a pool of available emergency system numbers. Because a different number may be used by a 911 operator with each call, it is not likely that a return call to wireless device 12 will use the same telephone number as was used during an initial contact. Thus, there is no straightforward way to identify that a call targeted for wireless device 12 originates from ESP 13 to help disable restrictions on incoming calls to wireless device 12 in the case of a callback from ESP 13.

Similarly, wireless device 12 may originate an SMS emergency text message, which is routed through base station 16 to SMSC/MMSC 18. SMSC/MMSC 18 directs the text message to ESP 13 through network 11. Emergency text messages routed through network 11 are forwarded to ESP 13 through signaling network 11b. ESP 13 may attempt to send a return SMS text message to mobile device 12 to ensure that the emergency situation has been resolved or is in the process of being resolved. The address or identifier of ESP 13 may not be recognized within profile database 15, and the return message from ESP 13 may be blocked due to restrictions placed on the operation of wireless device 12.

Other types of data communications from mobile device 12 may be made on an emergency basis through data session protocols, such as with an instant message (IM) or an email. Data session messages are passed from wireless device 12 through base station 16 to MDN 25 and then through IP network 27. The data session messages arrive at ESP 13 from IP network 27. Again, ESP 13 may attempt a return communication through a data session, such as an IM or email message. If wireless device 12 is restricted from receiving data session messages, the return communication from ESP 13 may not be permitted to pass to wireless device 12.

The presently disclosed system provides a means for permitting reception of emergency service communications at supervised wireless device 12 at a time when such communications might otherwise be restricted. The system and method disables restrictions that are applicable to supervised wireless device 12 to permit wireless device 12 to receive incoming communications, or alternatively identifies the communication as an emergency service communication to permit wireless device 12 to receive the communication.

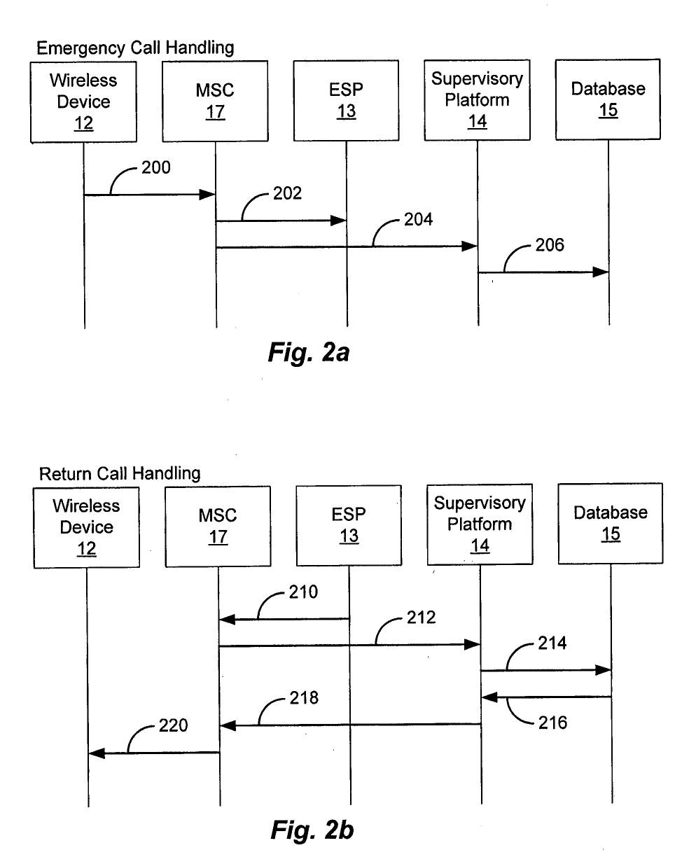

FIG. 2a shows a ping-pong diagram that illustrates process flows for voice communications involving supervised wireless device 12 and ESP 13. In path 200, a user places a 911 emergency call using a supervised wireless device 12. The call is conveyed to MSC 17 and directed to ESP 13 without restrictions or intervention by supervisory platform 14 as indicated with path 202. As illustrated by path 204, MSC 17 conveys a notification of the emergency call to supervisory platform 14. The notification includes the called number and the calling number. In response to receipt of the notification, database 15, which is coupled to or integrated with supervisory platform 14, is updated to reflect the fact that supervised wireless device 12 has initiated an emergency service communication as illustrated with path 206. Updating database 15 permits tracking of emergency service calls, and can contribute to detecting abuse of the system for removing call restrictions, for example.

Upon recognition of the call as being placed to an emergency service, supervisory platform 14 disables restrictions on the originating supervised wireless device 12 that could restrict the completion of a return communication from ESP 13. The system may permit restrictions to be disabled manually for a period of time defined by the operator or a supervisor of the supervised wireless device 12. Alternatively, the restrictions may be lifted automatically for a predefined period. The period of time may vary based on the carrier or the provider of the supervisory service. Alternatively, or in addition, the system may disable restrictions until a specific event occurs, such as detection of a return call from the contacted emergency service, for example.

FIG. 2b shows a ping-pong diagram that illustrates return call handling involving a return call from ESP 13. In path 210, ESP 13 initiates a return call to wireless device 12. MSC 17 receives and routes the call data to supervisory platform 14 as depicted by path 212. Supervisory platform 14 processes the call data to determine whether the call from ESP 13 to supervised wireless device 12 should be permitted to be completed. Supervisory platform 14 checks database 15 as illustrated by path 214 to determine whether wireless device 12 is restricted from incoming calls. Database 15 provides an indication to supervisory platform 14 regarding the status of restrictions on wireless device 12 as indicated by path 216. In an exemplary embodiment, supervisor platform 14 processes the restriction status to determine that the incoming call should be connected to wireless device 12, and signals MSC 17 of this determination as illustrated in path 218. MSC 17 then completes a call connection between ESP 13 and wireless device 12, as indicated by path 220. In this exemplary embodiment, all restrictions on incoming calls are disabled to permit any voice communications directed to wireless device 12 to be connected during the period in which restrictions are disabled. By disabling all restrictions on incoming calls to wireless device 12, supervisory platform 14 ensures that it does not block a return voice communication from an emergency service. It should be apparent that other scenarios for disabling restrictions on wireless device 12 may be used, such as in the case where all incoming calls except those on a black list may be connected.

In another embodiment, a return call from ESP 13 to wireless device 12 includes an indication that identifies the return call as having a high priority, or as being from an emergency service. In this embodiment, MSC 17 receives the call from ESP 13 that includes data associated with the call. The data includes an emergency priority indication. Upon determining that the call is of a priority or emergency nature, the call may be immediately connected to wireless device 12. This type of call processing may be conducted solely at MSC 17, with a notification of the call being forwarded to supervisory platform 14, which may record the priority call event in database 15.

In each of the cases described above, the detection of a priority indication may be used as an event for reestablishing call restrictions on wireless device 12. That is, upon supervisory platform 14 being notified of a priority call, or receiving call data that includes a priority indication, supervisory platform 14 may update database 15 to reestablish voice communication restrictions on wireless device 12. In this way, wireless device 12 is again restricted after completion of the emergency service call and the return call cycle.

When restrictions are disabled for wireless device 12, the restrictions need not be related to the original call placement. For example, FIGS. 2a and 2b depict a process for voice communications between wireless device 12 and ESP 13. When wireless device 12 places a call to ESP 13 and supervisory platform 14 detects the emergency situation, supervisory platform 14 may remove restrictions on incoming calls, incoming SMS text messages, IM communications, data sessions and so forth. In this way, if wireless device 12 is capable of communicating with one or more of the above described communications systems, the return communication from ESP 13 may take place in any one of the available communication channels. Once the time period for disabling restrictions on wireless device 12 has passed, or an event is detected that indicates restrictions should again be imposed on wireless device 12, supervisory platform 14 may reestablish restrictions on all or some of the communication channels, including voice, SMS, IM, data sessions and so forth.

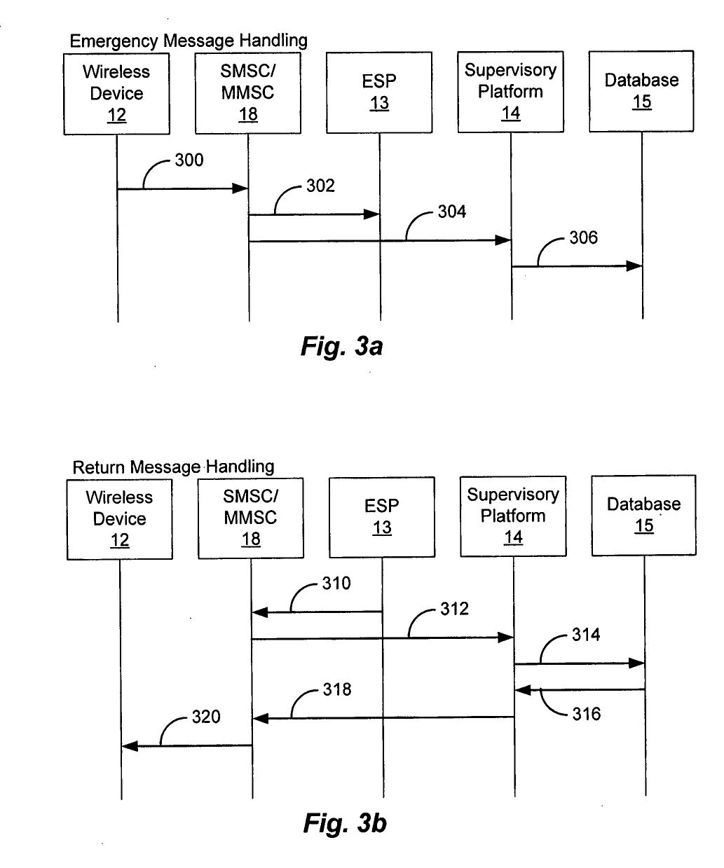

FIGS. 3a and 3b show ping-pong diagrams that illustrate handling of communications involving Simple Message Service (SMS) messages to and from an emergency service provider. In path 300, a mobile device user initiates an emergency service SMS/MMS message from wireless device 12 to a messaging gateway such as SMSC/MMSC 18. SMSC/MMSC 18 directly forwards the SMS/MMS message to ESP 13 as illustrated by path 302, thereby providing immediate notification from wireless device 12 to ESP 13 of the emergency condition. The notification includes identifying data for the source and destination of the message and information sufficient to identify the message as an emergency communication. In addition, SMSC/MMSC 18 forwards a notification to supervisory platform 14 as depicted by path 304. Supervisory platform 14 processes the notification and removes any applicable restrictions in database 15 that would prevent the receipt of a return message from ESP 13 to wireless device 12 associated with the message source identifier as illustrated by path 306.

FIG. 3b shows a ping-pong diagram that illustrates return message handling for SMS/MMS messages between ESP 13 and wireless device 12. In path 310, a return SMS/MMS message is transmitted from ESP 13 to supervised wireless device 12 that originated the emergency message as illustrated in FIG. 3a. The source and destination identifiers associated with the return message are communicated from SMSC/MMSC 18 to supervisory platform 14 as illustrated by path 312. Supervisory platform 14 checks the restriction status in database 15 as depicted in path 314, and determines the message should be allowed based on the result conveyed in path 316. Supervisory platform 14 then signals SMSC/MMSC 18 as illustrated by path 318 to indicate that the return message should be forwarded to wireless device 12. The return SMS/MMS message is then forwarded to wireless device 12, as illustrated in path 320.

As discussed above, once the return message from ESP 13 to wireless device 12 is permitted, restrictions on wireless device 12 may be reestablished. For example, once supervisory platform 14 is notified of the return message, as indicated in path 312, supervisory platform 14 may update database 15 to reestablish restrictions on incoming messages to wireless device 12. Alternatively, the restrictions may be reestablished based on events or a time interval, for example. More specifically, supervisory platform 14 may wait a predetermined time interval after notification of the original message from wireless device 12 or the return message from ESP 13 to reestablish restrictions on wireless device 12. Such a time interval may permit any additional messaging between wireless device 12 and ESP 13 to be completed before restrictions are again imposed on wireless device 12.

Supervisory platform 14 may restart or reset the time interval for removing restrictions from wireless device 12 in the event a message from wireless device 12 indicates an ongoing emergency situation. Similarly, supervisory platform 14 may provide logic that prevents the restrictions from being imposed on wireless device 12 if an ongoing emergency situation resets an event mechanism, such as a state machine, that might otherwise reestablish restrictions on wireless device 12. That is, the return message from ESP 13 may be used as an event to contribute to reestablishing restrictions on wireless device 12, but may be overridden if wireless device 12 causes an event that indicates an ongoing emergency situation.

Disabling and reestablishing restrictions in each cycle represented by FIGS. 3a and 3b is also possible. Supervisory platform 14 may disable restrictions upon notification of each emergency communication from wireless device 12, and may reestablish restrictions upon notification of each emergency communication from ESP 13 to wireless device 12.

As discussed above, disabling restrictions on wireless device 12 may include disabling all restrictions on all available communication channels, such as voice, SMS, IM, data session and so forth, or a subset of the available communication channels. Disabling restrictions may also be dependent upon other criteria such as black lists, so that outside communications from black listed sources are not permitted even when other restrictions are disabled.

Disabling or reestablishing restrictions on wireless device 12 may also include all or a subset of the available communication channels for wireless device 12. For example, if an emergency communication was made to ESP 13 through an SMS/MMS message, disabling or reestablishing restrictions on wireless device 12 may include the communication channel on which the communication was received, or all other available communication channels.

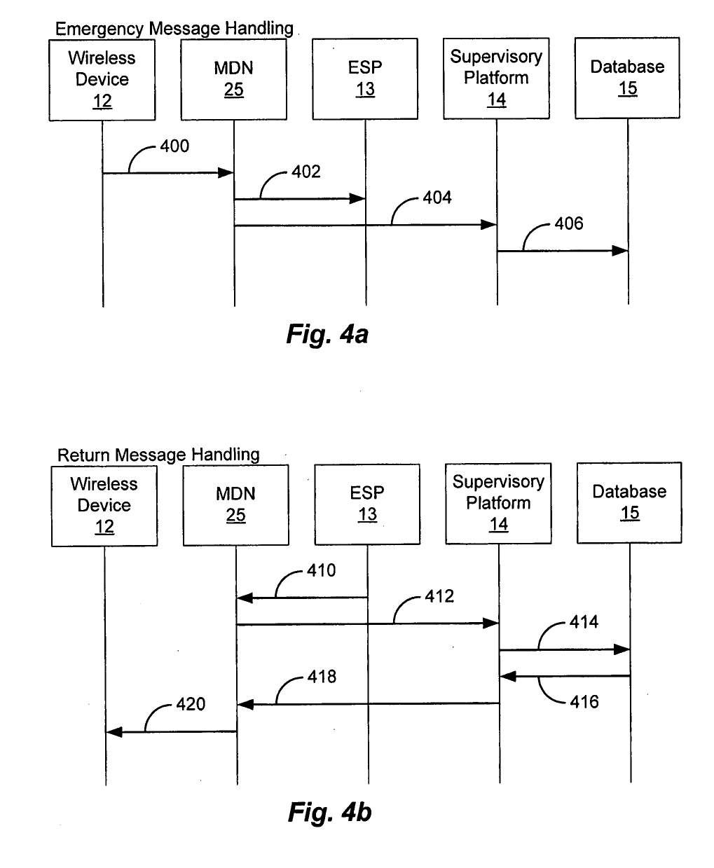

FIGS. 4a and 4b show ping-pong diagrams that illustrate emergency message handling for data session type communications, such as IM or email communications. In FIG. 4a, wireless device 12 initiates a data session as an emergency communication, such as an IM, as indicated by path 400. MDN 25 conveys the data session message directly to ESP 13, as indicated by path 402. In addition, MDN 25 conveys a notification of the emergency communication to supervisory platform 14 in path 404. The notification includes an identification of the source of and destination for the emergency message. Upon notification from MDN 25, supervisory platform 14 processes the source and destination identifiers, and updates database 15 to indicate that restrictions on return communications are disabled as depicted in path 406. Database 15 includes a restriction status for wireless device 12 that shows all or a subset of restrictions on wireless device 12 that are disabled after the update from supervisory platform 14. As discussed above, supervisory platform 14 may reestablish restrictions on wireless device 12 by updating database 15 after the expiration of a predetermined amount of time, or a change in state in an event mechanism. Any criteria for reestablishing restrictions on wireless device 12 may be maintained by a communications service provider, a supervisor for wireless device 12, or other manual or automatic mechanisms that may provide fixed or dynamic criteria for reestablishing restrictions following an emergency communication from wireless device 12 that resulted in the disabling of restrictions.

FIG. 4b shows a ping-pong diagram that illustrates return message handling for an IM, email or other data communications. An operator at ESP 13 may transmit a data session message to wireless device 12 following the original emergency communication from wireless device 12 to ensure that any emergency situation is resolved or in the process of being resolved. The data session message travels from ESP 13 to MDN 25 as indicated in path 410 via IP network 27. MDN 25, upon receipt of the data session message, provides a notification to supervisory platform 14 that includes message source and destination identifiers as illustrated by path 412. Supervisory platform 14 determines the status of restrictions on wireless device 12 by consulting database 15, as depicted by path 414. Database 15 returns the status of restrictions on wireless device 12 to supervisory platform 14 as illustrated by path 416. Supervisory platform 14 then instructs MDN 25 on the appropriate policy. In this exemplary embodiment, database 15 indicates that there are no restrictions on a data session message from ESP 13 to wireless device 12, and supervisory platform 14 instructs MDN 25 via gateway 26 and IP network 27 to permit the message to pass to wireless device 12, as illustrated by path 418. In response to the instruction from supervisory platform 14, MDN 25 forwards the message to wireless device 12 as illustrated by path 420.

As discussed above, the type or number of restrictions on wireless device 12 may be variously disabled or reestablished over the course of the processes illustrated in FIGS. 4a and 4b. In addition, any criteria for disabling or reestablishing restrictions on wireless device 12 may be used. For example, criteria may be based on time intervals, event mechanisms, white lists, black lists, various communication channel types and so forth. Restrictions may also be disabled or reestablished with each communication cycle between wireless device 12 and ESP 13, as discussed above.

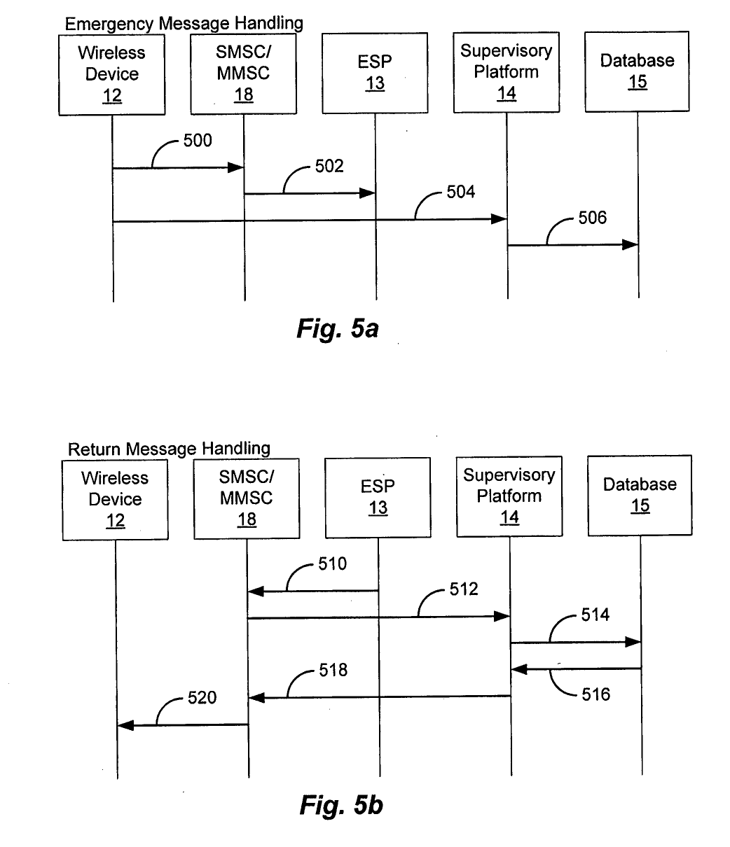

FIGS. 5a and 5b show ping-pong diagrams that illustrate an alternate method of emergency message handling for SMS/MMS type messaging. In FIG. 5a, wireless device 12 sends an emergency SMS/MMS type message to ESP 13, which is received first at SMSC/MMSC 18 as depicted in path 500. In this exemplary embodiment, application software within wireless device 12 detects that an emergency message has been sent to ESP 13, and provides a notification to supervisory platform 14 as illustrated by path 504. SMSC/MMSC 18, upon receiving the emergency message from wireless device 12 immediately forwards the message to ESP 13 as illustrated in path 502. Upon being notified by wireless device 12, supervisory platform 14 updates database 15 as illustrated by path 506 to remove restrictions from wireless device 12 that would prevent a return SMS/MMS message from being received. ESP 13 may then respond to wireless device 12 without restriction.

FIG. 5b illustrates ESP 13 responding to wireless device 12 with an SMS/MMS message. ESP 13 directs a message to wireless device 12, and the message is received at SMSC/MMSC 18 as illustrated by path 510. SMSC/MMSC 18 provides a notification to supervisory platform 14 that includes message source and destination identifiers as illustrated by path 512. Supervisory platform 14 checks the status of restrictions on wireless device 12 by querying database 15 as depicted by path 514. The information returned from database 15 to supervisory platform 14 indicates that the message from ESP 13 should be forwarded to wireless device 12 without restriction as depicted by path 516. Supervisory platform 14 then instructs SMSC/MMSC 18 to deliver the message from ESP 13 to wireless device 12 as illustrated by path 518. SMSC/MMSC 18, upon being instructed by supervisory platform 14, forwards the message to wireless device 12 as illustrated by path 520.

In the case of SMS/MMS messages and data sessions including IM and email communications, restrictions on wireless device 12 are disabled to permit emergency communications in either direction between wireless device 12 and ESP 13. Accordingly, a number of messages may be exchanged between wireless device 12 and ESP 13 during an interval in which restrictions on wireless device 12 are disabled. FIGS. 5a and 5b illustrate one cycle of message communications between wireless device 12 and ESP 13 while restrictions are lifted. Each time wireless device 12 communicates with ESP 13, supervisory platform 14 is notified and may restart a timing interval or update an event counter, for example. The timer interval or event counter may be used to determine when messaging restrictions on wireless device 12 are reestablished. As discussed above, the restrictions that are maintained on wireless device 12 may be based on various criteria or policies. Additionally, restrictions may be disabled for data communications only or for some or all of other available communication channels.

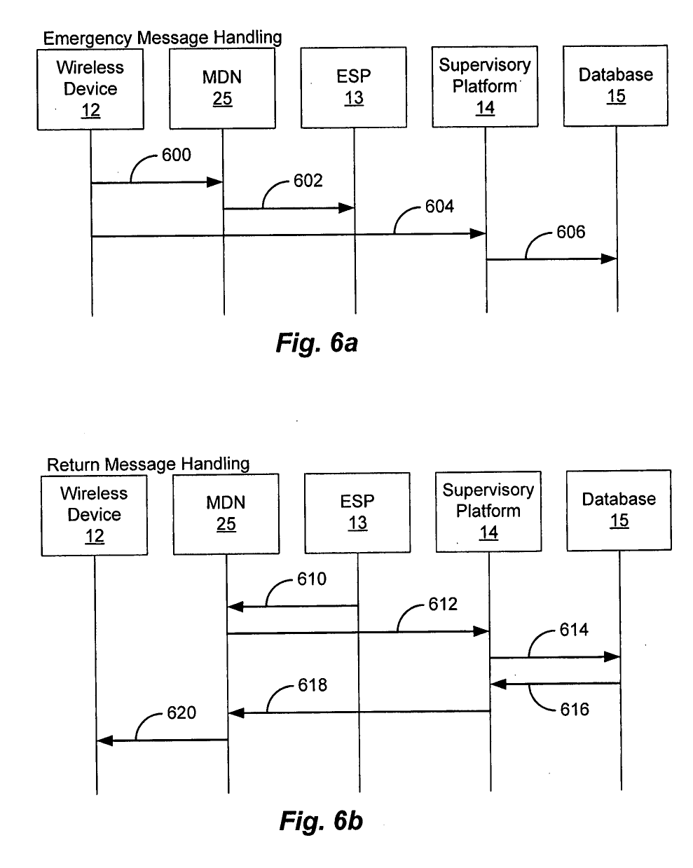

FIGS. 6a-6b show ping-pong diagrams that illustrate emergency message handling for data sessions such as IM and email communications. In FIG. 6a, wireless device 12 initiates an emergency communication to ESP 13 in the form of a data session. The emergency message is forwarded from wireless device 12 to MDN 25 as illustrated by path 600, and is forwarded directly to ESP 13 as depicted in path 602. Alternately, or in addition, MDN 25 may forward the emergency message to ESP 13 over IP network 27. In this exemplary embodiment, wireless device 12 includes operational functionality, realized in hardware or software or both, to detect an emergency service communication and to provide notification to supervisory platform 14 as indicated in path 604 via a data communication. Referring to FIG. 1, the notification from wireless device 12 to supervisory platform 14 may traverse different paths. For example, the notification may be via base station 16, MDN 25, IP network 27 and data gateway 26. Alternately, the notification from wireless device 12 to supervisory platform 14 may be via base station 16, SMSC/MMSC 18 and signaling network 11b. In either case, supervisory platform 14 receives notification of an emergency communication from wireless device 12 and updates database 15 to remove restrictions on wireless device 12 as illustrated by path 606.

FIG. 6b shows ESP 13 sending a data communication reply to wireless device 12, which is received at MDN 25 as indicated in path 610. MDN 25 notifies supervisory platform 14 of the emergency response message as illustrated by path 612 and provides message source and destination identifiers to supervisory platform 14. Supervisory platform 14 checks the restriction status of wireless device 12 by querying database 15 as illustrated by path 614. The result of the query on database 15 is provided to supervisory platform 14 as illustrated by path 616. Supervisory platform 14 determines that the message should be permitted, and instructs MDN 25 accordingly as illustrated by path 618. In response to instructions from supervisory platform 14, MDN 25 forwards the emergency data session message to wireless device 12 as illustrated by path 620.

The messaging between wireless device 12 and ESP 13 can continue for a number of cycles as illustrated in FIGS. 6a and 6b without restrictions imposed on wireless device 12 that might otherwise block communications from ESP 13. Supervisory platform 14 may continuously update database 15 each time there is a notification of a message from wireless device 12 to ESP 13. Supervisory platform 14 may also reset a timer or update an event counter each time an emergency message notification is received. Accordingly, the user of wireless device 12 and the operator at ESP 13 can exchange a number of messages without any restrictions on wireless device 12. Alternately, restrictions on wireless device 12 may be disabled and reestablished with each communication cycle between wireless device 12 and ESP 13, as discussed above.

As with other communication channels discussed above, the type and number of restrictions on wireless device 12 that may be applied or disabled with respect to data communications can vary, depending upon setup or application, for example. Supervisory platform 14 may continue to restrict incoming messages to wireless device 12 that are found on a black list located in database 15, for example, even while other restrictions may be disabled.

The above described communications with an emergency service provider may be tracked. Information regarding the initiation of communications with emergency services may be provided in the form of a notification or report available to a supervisor or operator of a supervisory account associated with a supervised wireless device. The notification or report may be made accessible through the supervisory platform so that the operator or supervisor can review communications with the emergency service provider. The communications that are tracked and for which notifications or reports are provided may include voice, text or multimedia messaging and data sessions, such as Instant Messaging (IM) or emails. The operator or the supervisor responsible for the supervised account associated with the supervised wireless device can determine if there is any misuse associated with emergency communications to an emergency service provider, for example.

As discussed above, emergency messages provided by ESP 13 may include an indication of priority or emergency classification to speed delivery of the messages over network 11 or IP network 27, for example. For communications involving supervised wireless device 12, source and destination data including the priority indication may be passed to supervisory platform 14 to indicate when any communication from ESP 13 to wireless device 12 are taking place. Supervisory platform 14 may detect the priority indication to trigger events such as a timeout for restriction disablement timers or to trigger events to reestablish restrictions on wireless device 12, for example.

The indication provided in the emergency service return communication may be a priority bit contained within communication packets or call data associated with the return communication from ESP 13. The priority bit may be used by network elements including supervisory platform 14 to identify the return communication as an emergency communication and may be used by supervisory platform 14 to over-ride restrictions for supervised wireless device 12 that might otherwise prevent connection or completion of the communication.

It will be appreciated by those of ordinary skill in the art that further modifications to and variations of the above-described extended defect sizing technique may be made without departing from the inventive concepts disclosed herein. Accordingly, the invention should not be viewed as limited except as by the scope and spirit of the appended claims.

What is claimed is:

1. A method for permitting return calls from an emergency service provider in a system including a supervisory platform operative to impose restrictions on incoming calls to a wireless device in accordance with one or more parameters stored in a database accessible to the supervisory platform, comprising:
in association with a call to an emergency service provider, receiving an indication at the supervisory platform that a communication to the emergency service provider has been placed; and
responsive to the indication, disabling at least one of the restrictions imposed by the supervisory platform that would prevent the emergency service provider from completing a communication to the wireless device.

2. The method according to claim 1, further comprising disabling a restriction that is one or more of a time restriction, an incoming call restriction or an incoming electronic message restriction.

3. The method according to claim 1, wherein disabling at least one of the restrictions further comprises disabling all restrictions on incoming calls or messages.

4. The method according to claim 1, wherein disabling at least one of the restrictions further comprises disabling a subset of restrictions based on the type of call.

5. The method according to claim 1, further comprising a call type being one or more of an SMS, an MMS, an IM, an email or voice communication.

6. The method according to claim 1, further comprising reestablishing restrictions on incoming calls to the wireless device in accordance with a given criteria.

7. The method according to claim 6, wherein the criteria is a time interval specified by one or more of a carrier, supervisor profile, system definition or by action of a system administrator.

8. The method according to claim 6, wherein the criteria further comprises an event being one or more of a detected incoming call from the emergency service provider, an incoming call with a priority indication or a system administrator action based on an incoming call identified with the emergency service provider.

9. The method according to claim 1, wherein the call to or incoming call from the emergency service provider is implemented as one or more of a message to an IP address, a message to a short code ID, or a message to a telephone number.

10. A system for permitting an emergency service provider to communicate with a wireless device that is operative to be restricted from receiving incoming calls, comprising:
a database for maintaining identification of the wireless device and restrictions to be imposed on the wireless device;
a supervisory platform coupled to the database and operative to receive an indication that a communication to the emergency service provider has been placed with the wireless device; and
the supervisory platform being further operative in response to the indication to disable at least one restriction imposed on the wireless device that would prevent the emergency service provider from completing a communication to the wireless device.

11. The system according to claim 10, wherein the restrictions are one or more of time based restrictions, incoming call ID restrictions or incoming message ID restrictions.

12. The system according to claim 10, wherein the supervisory platform is further operative to disable all restrictions on the wireless device.

13. The system according to claim 10, wherein the supervisory platform is further operative to disable restrictions based on the type of call.

14. The system according to claim 10, further comprising a type of call being one or more of an SMS, MMS, IM, email or voice communication.

15. The system according to claim 10, wherein the supervisory platform is further operative to reestablish restrictions on the wireless device in accordance with a given criteria.

16. The system according to claim 15, wherein the criteria is a time interval established by one or more of a carrier, supervisory profile, system definition or by action of an administrator.

17. The system according to claim 15, wherein the supervisory platform is further operative to reestablish restrictions on the wireless device in accordance with an event being one or more of a detected incoming call from the emergency service provider, an incoming call priority indication or a system administrator action based on an incoming call identified as originating from the emergency service provider.

18. The system according to claim 10, wherein the outgoing call or incoming call is addressed based on an IP address, a short code ID or a telephone number.

19. A method of operating a communication system that can impose restrictions on a communication device coupled to the communication system and remove restrictions on the communication device in the event of communication with an emergency service provider, the method comprising:
receiving notification at a supervisory platform in the communication system that a call to the emergency service provider has been placed with the communication device; and
disabling at least one of the restrictions imposed on the communication device that would prevent the emergency service provider from completing a return call to the communication device.

20. The method according to claim 19, further comprising disabling at least one of the restrictions based on a resetable time interval.
